(19) United States
(12) Patent Application Publication
(10) Pub. No.: US 2006/0181331 A1
(43) Pub. Date: Aug. 17, 2006

(54) Trimming fuse circuit with latch

(75) Inventor: Fomin Uladzimir, Minsk (BY)

Correspondence Address: BRUCE H. TROXELL, SUITE 1404, 5205 LEESBURG PIKE, FALLS CHURCH, VA, 22041, US

(73) Assignee: Neotec Semiconductor Ltd.

(21) Appl. No.: 11/346,347

(22) Filed: Feb. 3, 2006

(30) Foreign Application Priority Data
Feb. 15, 2005 (TW) 94104334

(51) Int. Cl. H01H 37/76

(52) U.S. Cl. 327/525

(57) ABSTRACT

A trimming fuse circuit with a latch is disclosed. The trimming fuse circuit includes: a first CMOS transistor having a first PMOS and a second NMOS, wherein said first PMOS has a size smaller than that of said first NMOS; a second CMOS transistor having a second PMOS and a second NMOS, wherein said second PMOS has a size larger than that of said second NMOS, and still an input terminal of said second CMOS is cross-coupled with an output terminal of said first CMOS, furthermore, an output terminal of said first CMOS is cross-coupled with an input terminal of said second CMOS; and a fuse connected in between said input terminal of said first CMOS transistor and ground; thus, outputting an voltage high control signal from said output terminal of said first CMOS while said voltage high fuse is not burned-out; and outputting an voltage low control signal voltage low whiles said fuse is burned-out.

### BACKGROUND OF THE INVENTION

(1) Field of the Invention

The invention relates to a trimming fuse circuit, and more particularly, to a trimming fuse circuit with a latch.

(2) Description of the Prior Art

Recently, with advance of photolithography technology and etching technology in semiconductor industry, the integrity density of single chip is almost three orders of magnitude than ten years ago. The advance of semiconductor processes make a great contribution that is second to none, and memory cell repair concept as well as trimming fuse circuit also make a great contribution. During each of semiconductor process, dies on wafer must be precisely processed and precisely controlled, which is a high technology. Especially, when in deep sub-micro era, and even in nanometer era, passive elements, particularly, precise control of resistance of polysilicon is getting more and more difficulty. The reason is that when elements are miniature, the control of doping impurity concentration is very sensitive to doping and anneal condition.

Therefore, in order to increase yield, although electrical performance of die is lower than expected, and is in a tolerable condition after testing, adjusting the resistance of the circuit by using a trimming fuse circuit is very important. Generally, the trimming fuse circuit that includes a plurality of fuses, a few control signals, and several resistors that are connected in series, is to adjust an optimum or a desired current path. Once an electrical performance result is satisfied after testing, then the desired current path is saved, and the redundant fuses are burnt-out by high current or by laser, which are guided by pre-determined control signals.

Regarding the trimming circuit in the prior art, please refer to U.S. Pat. No. 5,361,001 which was granted to Mr. David L. Stolfa on Nov. 1, 1994. FIG. 1 shows a circuit diagram of the trimming fuse circuit in accordance with the prior art. The trimming fuse circuit includes a resistor R and a fuse F in series connected. The node between the resistor R and the fuse F is an output control terminal therefrom outputting a control signal to a circuit to be trimmed. The circuit to be trimmed usually includes a plurality of switch elements and a plurality of passive elements (not shown). Whether the fuse is burnt-out or not can determine that V_{c} level voltage at output control terminal is high or low, in order to make the switch elements ON or OFF, and to adjust resistance of the circuit.

Generally, the lower current flows through the output control terminal, the better it is. This is because the lower current can avoid causing problem in voltage deviation of the circuit to be trimmed. Therefore, to reduce the current that enters the circuit to be trimmed, the resistance of the resistor R in the trimming fuse circuit must be maximum. That is, the trimming fuse circuit will occupy a great area on wafer for having greater resistance of the resistor R, which thus, causes the fact that the trimming fuse circuit cannot be shrunk.

In view of aforesaid, the present invention provides a trimming fuse circuit, which can effectively narrow down layout area of the trimming fuse circuit, and can reduce the current that flows into the circuit to be trimmed.

### SUMMARY OF THE INVENTION

The present invention provides a trimming fuse circuit.

According to the embodiment, the trimming fuse circuit with a latch includes: a first complementary metal-oxide-semiconductor transistor (CMOS transistor), a second CMOS transistor, and a fuse. The first CMOS transistor has a small p-type transistor i.e., a lower ratio of width versus channel length; W/L, and a large n-type transistor in size. The second one has a large p-type transistor and a small n-type transistor, and input terminal and output terminal of the large p-type transistor and the small n-type transistor are cross-coupled with input terminal and output terminal of the first CMOS transistor, wherein the output terminal of the first CMOS transistor outputs a control signal. The fuse is connected to the node between the input terminal of the first CMOS transistor and a ground. When a voltage high control signal is desired, then the fuse is not burned-out. On the other hand, when a low voltage control signal is desired, then the input terminal of the first CMOS transistor is coupled with the voltage high control signal, and the fuse is burned-out.

### BRIEF DESCRIPTION OF THE DRAWINGS

The present invention will now be specified with reference to its preferred embodiment illustrated in the drawings, in which:

FIG. 1 is a diagram of trimming fuse circuit in the prior art;

FIG. 2 is a diagram of a trimming fuse circuit with a latch of the present invention, in which the fuse is not burned-out;

FIG. 3 is the diagram of the trimming fuse circuit with the latch of the present invention, in which the fuse is burned-out.

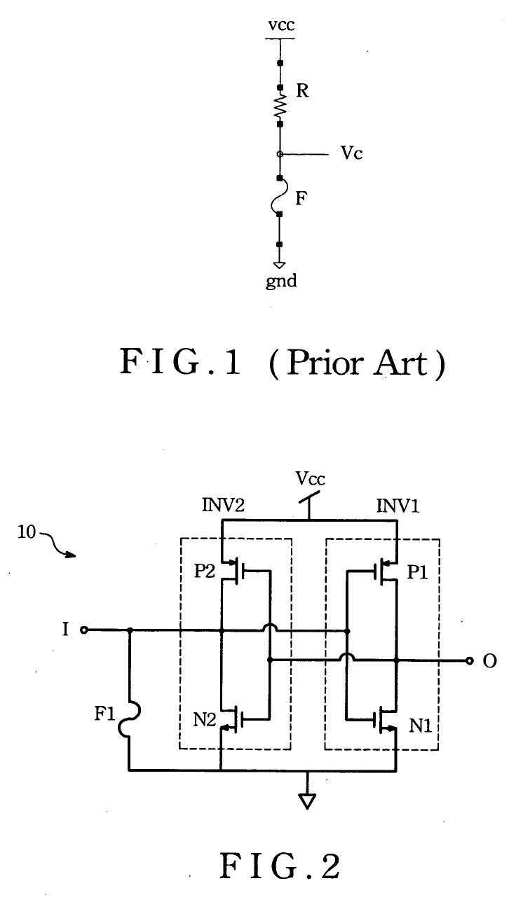

### DESCRIPTION OF THE PREFERRED EMBODIMENTS

The trimming circuit provides control signals to switch the transistors of the circuit to be trimmed, however, it is unavoidable to provide some extra pull up currents or pull down currents to the circuit to be trimmed, results in the voltage or signal departure from the predetermined values. Hence, the outputting of the trimming circuit is desired to be small.

The circuit is composed of two CMOS, and a fuse in accordance with the present invention. The first CMOS is a smaller PMOS P1 in size plus a larger NMOS N1 in size, wherein the size is the ratio of width versus channel length, i.e., the W/L. By contrast, the second one is a larger PMOS P2 plus a smaller NMOS N2. In a preferred embodiment, the ratio of the W/L of PMOS P1 is about 1 μm/10 μm, designated by (W/L)_{P1}≈1 μm/10 μm. Similarly, (W/L)_{N1}≈20 μm/0.5 μm. The ratio of the W/L of PMOS P2 is about 20 μm/0.5 μm, designated by (W/L)_{P2}≈20 μm/0.51 μm. Similarly, (W/L)_{N1}≈1 μm/10 μm. The input terminals of the first CMOS is cross-coupled with the output terminals of the second CMOS.

As is understood by a person skilled in the art, the foregoing W/L ratios, respectively, for each transistor is an illustration for convenience rather than limitation thereon. It is intended to cover various modifications and similar arrangements included within the spirit and scope of the appended claims, the scope of which should be accorded the broadest interpretation so as to encompass all such modifications and similar structure.

When a voltage high is desired to be outputted to the circuit to be trimmed (hereinafter called internal circuit), the current flows to the internal circuit through the small PMOS, and by means of small size thereof having high resistance, only a very tiny current associated with the control signal will be outputted to the internal circuit. By contrast, when a voltage low is desired to be outputted to the internal circuit, the major current flows to the ground through the large NMOS that has a low resistance. The outputted voltage low control signal still has the tiny current to flow into the internal circuit, thus effectively reducing pull-up current or pull-down current that flows into the internal circuit.

As shown in FIG. 2, the trimming fuse circuit with the latch includes: a fuse F1, a first inverter INV1 and a second inverter INV2. The first inverter INV1 is one CMOS transistor which consists of a small p-type transistor P1 plus a large n-type transistor N1. Moreover, an input terminal of the INV1 is used as a signal input terminal IN, and an output terminal of the INV1 is used as a control signal output terminal OUT. The inverter INV2 consists of a large p-type transistor P2 plus a small n-type transistor N2. Moreover, an input terminal of the INV2 is coupled with the output terminal O of the INV1. An output terminal of the INV2 is coupled with the input terminal IN of the INV1. The fuse F1 is connected in between the input terminal IN and ground(GND).

In the circuit, the fuse F1 is connected in between the input terminal IN and ground. Before burning out the fuse F1, the voltage at the terminal IN is thus grounded, so that the transistor P1 is ON, and the transistor N1 is OFF, and thus pulls the voltage of the terminal OUT to VCC. The terminal OUT in VCC state turns on the transistor N2, and turns off the transistor P2. Therefore, the control signal at the terminal OUT is latched at voltage high. It should be noted that in the embodiment of the present invention, because of small sizes of the transistor P1 and transistor N2, the current that flows out of the terminal OUT is reduced.

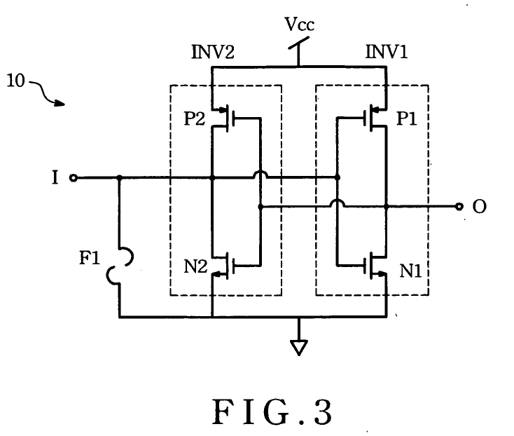

Please refer to FIG. 3, which shows the circuit diagram. When the fuse F1 is burned-out by high current or by laser, the transistor P1 and transistor N2 have small size characteristics, i.e., high resistance. So, the level voltage at the terminal IN reaches to the voltage high. At the same time, the transistor N1 is ON, and the transistor P1 is OFF. Thus, the drain (terminal OUT) of the transistor N1 outputs a signal that is the voltage low. By contrast, when the transistor P2 is ON, and the transistor N2 is OFF, voltage level at the drain of the transistor reaches to the voltage high, i.e., VCC. Similarly, the control signal that is outputted from the terminal OUT is latched as voltage low.

Because the transistor N1 and the transistor P2 have the relatively large in size, i.e., low resistance, most of the pull-down current flows to the ground through the transistor N1, and only very tiny pull-down current flows to the terminal OUT.

The circuit of the present invention has the following advantages.
(1) Because the trimming fuse circuit of the present invention does not use resistor element, the layout area can be effectively reduced.
(2) According to the latch of the present invention, the pull-up current or pull-down current does not need to be supplied to the input terminal IN, which means that the power consumption can be saved.
(3) By means of size adjustment to the transistors according to the present invention, the current that is outputted to the internal circuit can be effectively reduced.

While the present invention has been particularly shown and described with reference to a preferred embodiment, it will be understood by those skilled in the art that various changes in form and detail may be without departing from the spirit and scope of the present invention.

What is claimed is:

1. A trimming fuse circuit, comprising:
a first CMOS transistor having a first PMOS and a second NMOS, wherein said first PMOS has a size smaller than that of said first NMOS;
a second CMOS transistor having a second PMOS and a second NMOS, wherein said second PMOS has a size larger than that of said second NMOS, and still an input terminal of said second CMOS is cross-coupled with an output terminal of said first CMOS, furthermore, an output terminal of said first CMOS is cross-coupled with an input terminal of said second CMOS; and
a fuse connected in between said input terminal of said first CMOS transistor and ground;
thus, outputting an voltage high control signal from said output terminal of said first CMOS while said voltage high fuse is not burned-out; and outputting an voltage low control signal voltage low while said fuse is burned-out.

2. The trimming fuse circuit according to claim 1, wherein said control signal latched is in response to an input signal from said first CMOS transistor.
